(19) United States
(12) Patent Application Publication
(10) Pub. No.: US 2024/0028140 A1
(43) Pub. Date: Jan. 25, 2024

(54) ROLLER INPUT DEVICE

(71) Applicant: Chicony Electronics Co., Ltd., New Taipei City (TW)

(72) Inventor: Yu-Chih Cheng, New Taipei City (TW)

(21) Appl. No.: 18/331,259

(22) Filed: Jun. 8, 2023

(30) Foreign Application Priority Data
Jul. 21, 2022 (TW) 111127442

(51) Int. Cl. G06F 3/0362

(52) U.S. Cl. CPC G06F 3/0362

(57) ABSTRACT

A roller input device includes a base, an active roller, a passive roller, and an actuation member. The active roller is disposed on the base and includes a first limiting structure and a first magnetic member. The passive roller is disposed on the base and includes a second limiting structure and a second magnetic member. A magnetic repulsion force is between the first magnetic pole of the first magnetic member and the second magnetic pole of the second magnetic member. When the actuation member is in a first mode, the actuation member drives the passive roller to move adjacent to the active roller. When the actuation member is in a second mode, the actuation member releases the passive roller to allow the magnetic repulsion force to drive the passive roller to move away from the active roller.

### CROSS-REFERENCE TO RELATED APPLICATION

This non-provisional application claims priority under 35 U.S.C. § 119(a) to Patent Application No. 111127442 filed in Taiwan, R.O.C. on Jul. 21, 2022, the entire contents of which are hereby incorporated by reference.

### BACKGROUND

### Technical Field

The instant disclosure relates to an input device, in particular, to a roller input device.

### Related Art

Commonly, computers are used along with roller input devices. For example, the roller input device may be provided on a keyboard or a mouse, and the user can use the roller input device to perform actions, such as dragging item(s), scrolling pages, or switching menu(s).

### SUMMARY

A roller input device known to the inventor includes a roller and an elastic member, wherein the main body of the roller has a toothed surface, and the elastic member abuts against the toothed surface of the main body of the roller. Therefore, when the roller is operated so as to be rotated, the user will have a stepped operation feeling. For example, every time the roller is rotated with a certain scale, the user will feel the roller is temporary stopped, and the page shown on the monitor is scrolled by a preset distance. However, such roller input device with a single operation mode is not sufficient to meet some operation scenarios (such as the user has to operate the roller for a long time or for a long distance, or the user has to allow the roller to perform a more finely scroll operation).

In view of this, in one embodiment, a roller input device is provided. The roller input device comprises a base, an active roller, a passive roller, and an actuation member. The active roller is rotatably disposed on the base. The active roller comprises a first limiting structure and a first magnetic member, and the first magnetic member has a first magnetic pole. The passive roller is rotatably disposed on the base. The passive roller comprises a second limiting structure and a second magnetic member, and the second magnetic member has a second magnetic pole. The first magnetic member and the second magnetic member are adjacent to each other, and a polarity of the first magnetic pole is the same as a polarity of the second magnetic pole, so that a magnetic repulsion force is between the first magnetic pole and the second magnetic pole. The actuation member is capable of being selectively switched to a first mode or a second mode. When the actuation member is in the first mode, the actuation member drives the passive roller to move adjacent to the active roller, so that the first limiting structure and the second limiting structure are assembled with each other, and the active roller and the passive roller rotate synchronously. When the actuation member is in the second mode, the actuation member releases the passive roller to allow the magnetic repulsion force to drive the passive roller to move away from the active roller, so that the first limiting structure and the second limiting structure are separated from each other.

Based on the above, in the roller input device according to one or some embodiments of the instant disclosure, the actuation member can be switched to the first mode or the second mode, so that the active roller and the passive roller can rotate synchronously or can be separated from each other. Hence, the roller input device can be switched to different operation modes to meet users' different operation requirements.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic view showing the operation of a roller input device according to an exemplary embodiment of the instant disclosure;

FIG. 2 illustrates a schematic view showing the operation of a roller input device according to another exemplary embodiment of the instant disclosure;

FIG. 3 illustrates a perspective view of a roller input device according to a first embodiment of the instant disclosure;

FIG. 4 illustrates an exploded view of the roller input device of the first embodiment;

FIG. 5 illustrates an exploded partial view of the roller input device of the first embodiment;

FIG. 6 illustrates an exploded partial view of a roller input device according to a second embodiment of the instant disclosure;

FIG. 7 illustrates a cross-sectional view showing that an actuation member according to an exemplary embodiment of the instant disclosure is in a first mode;

FIG. 8 illustrates another cross-sectional view showing that the actuation member of the exemplary embodiment is in the first mode;

FIG. 9 illustrates a cross-sectional view showing that the actuation member of the exemplary embodiment is in a second mode;

FIG. 10 illustrates another cross-sectional view showing that the actuation member of the exemplary embodiment is in the second mode;

FIG. 11 illustrates a cross-sectional view of a roller input device according to a third embodiment of the instant disclosure;

FIG. 12 illustrates a cross-sectional view of a roller input device according to a fourth embodiment of the instant disclosure;

FIG. 13 illustrates a schematic view showing the operation of the roller input device of the fourth embodiment;

FIG. 14 illustrates a lateral view of a roller input device according to a fifth embodiment of the instant disclosure;

FIG. 15 illustrates a schematic view showing the operation of the roller input device of the fifth embodiment; and

FIG. 16 illustrates a partial perspective view of a roller input device according to a sixth embodiment of the instant disclosure.

### DETAILED DESCRIPTION

Embodiments are provided for facilitating the descriptions of the instant disclosure. However, the embodiments are provided as examples for illustrative purpose, but not a limitation to the instant disclosure. In all the figures, the same reference numbers refer to identical or similar elements.

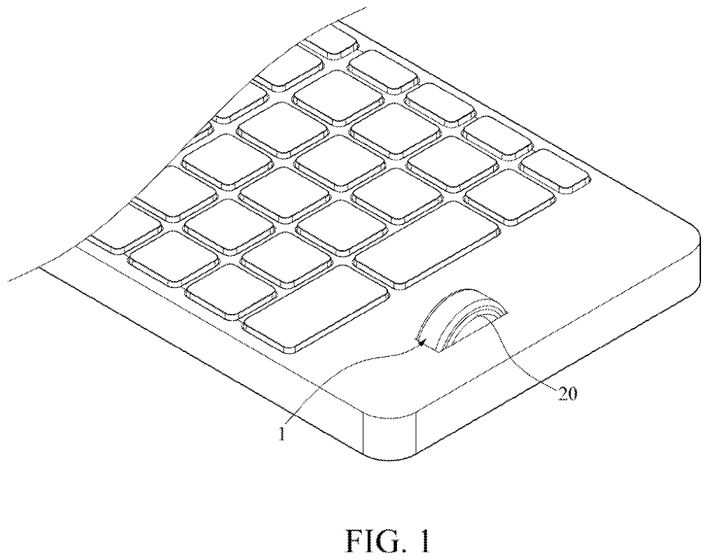

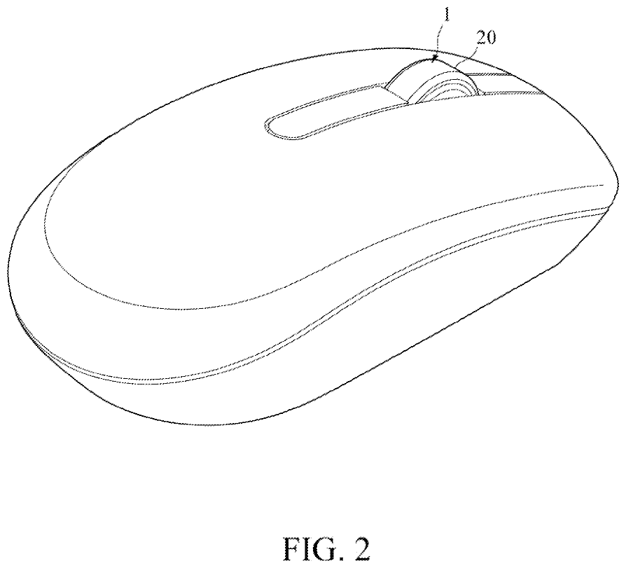

As shown in FIG. 1, the roller input device 1 according to the exemplary embodiment of the instant disclosure is an input device of a computer, and the roller input device 1 is adapted to manipulate the page shown on the computer to perform certain actions (such as dragging items, scrolling the page upward or downward, or switching menus). In this embodiment, the roller input device 1 and the keyboard of the computer are integrated as a one-piece member. In another embodiment, as shown in FIG. 2, the roller input device 1 may be applied to a mouse of a computer, and the instant disclosure is not limited thereto.

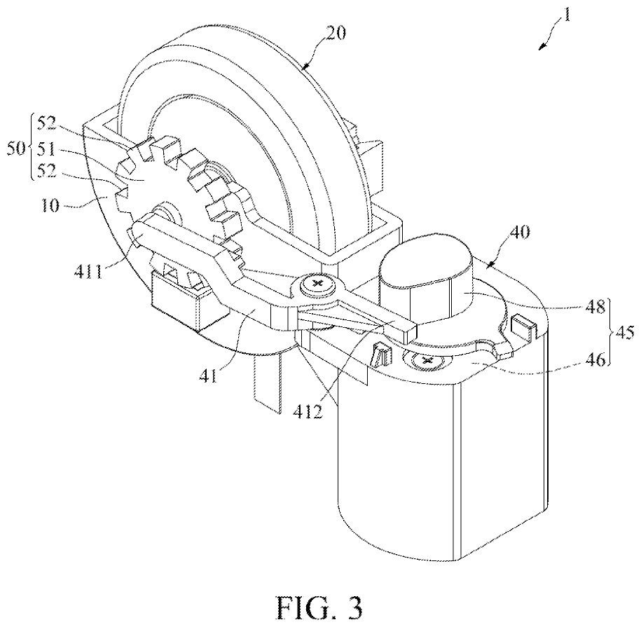

As shown in FIG. 3 to FIG. 5, the roller input device 1 comprises a base 10, an active roller 20, a passive roller 30, and an actuation member 40. The active roller 20 and the passive roller 30 are rotatably disposed on the base 10. In other words, in this embodiment, when the active roller 20 and the passive roller 30 are subjected to an external force, the active roller 20 and the passive roller 30 can be rotated with respect to the base 10. Moreover, as shown in FIG. 1 and FIG. 2, a portion of the active roller 20 (in this embodiment, the upper portion) is exposed from the housing of the keyboard or the mouse of the computer so as to be operated by the user. For example, the user can roll the active roller 20 to scroll the page upward or downward.

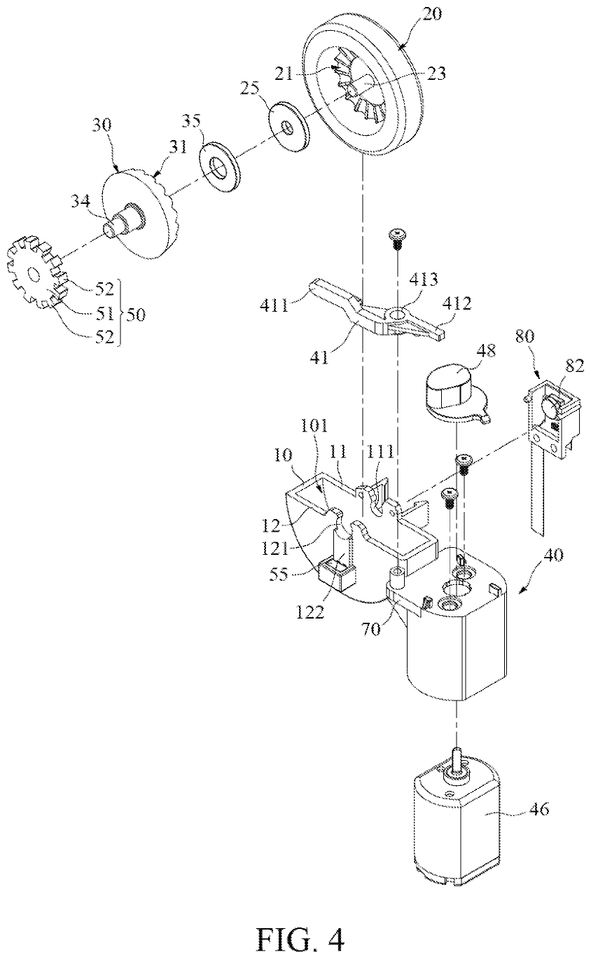

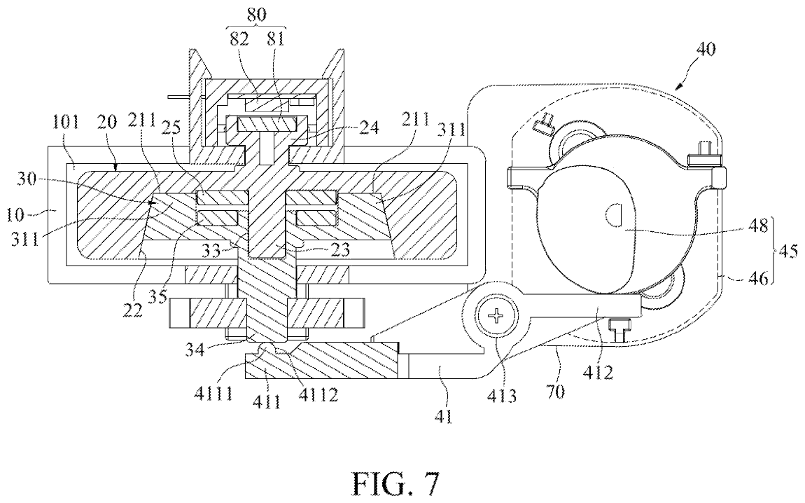

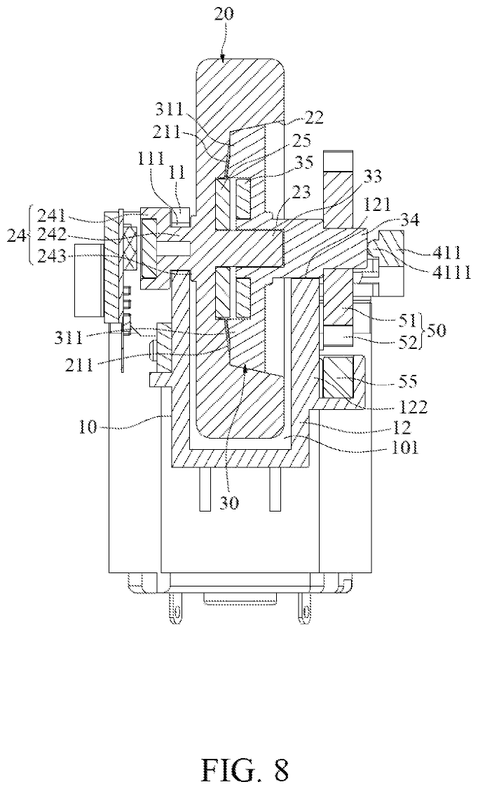

With reference to FIG. 4, FIG. 7, and FIG. 8. In this embodiment, the base 10 is a semicircular hollowed housing and has a receiving groove 101, and the base 10 has a first sidewall 11 and a second sidewall 12 opposite to the first sidewall 11. The first sidewall 11 has a first pivot portion 111. The second sidewall 12 has a second pivot portion 121. A first rotation shaft 24 is on the axis of the active roller 20, and a second rotation shaft 34 is on the axis of the passive roller 30. A portion of the active roller 20 and a portion of the passive roller 30 (in this embodiment, the lower portion) are received in the receiving groove 101, the first rotation shaft 24 of the active roller 20 is pivotally connected to the first pivot portion 111, and the second rotation shaft 34 of the passive roller 30 is pivotally connected to the second pivot portion 121. The active roller 20 and the passive roller 30 may be assembled with each other to form an assembly, and then the assembly is assembled in the receiving groove 101 of the base 10. In some embodiments, the first pivot portion 111 and the second pivot portion 121 may be open grooves (as shown in FIG. 4) or closed shaft holes, respectively.

Furthermore, as shown in FIG. 8, in this embodiment, the first rotation shaft 24 of the active roller 20 has a first section 241, a middle section 242, and a second section 243. The middle section 242 is connected between the first section 241 and the second section 243, and the middle section 242 is in the first pivot portion 111. The diameter of the first section 241 is greater than the diameter of the middle section 242, and the diameter of the second section 243 is greater than the diameter of the middle section 242. Therefore, the first sidewall 11 can be sandwiched between the first section 241 and the second section 243, and axial shift of the active roller 20 can be prevented after the active roller 20 is assembled with the base 10. Hence, the active roller 20 can be properly limited.

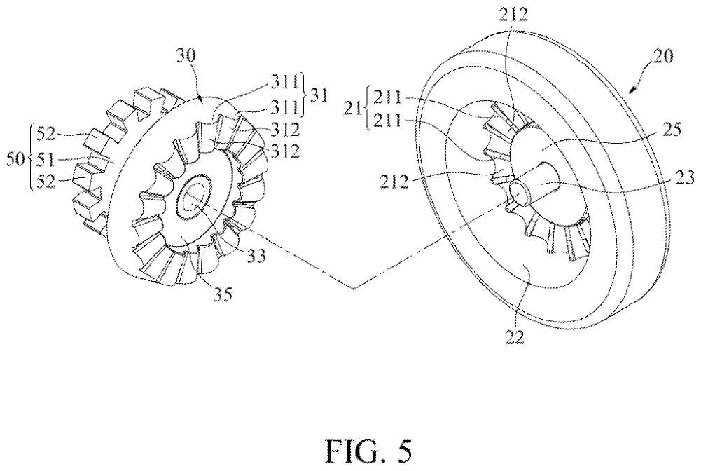

As shown in FIG. 4 and FIG. 5, the active roller 20 comprises a first limiting structure 21 and a first magnetic member 25, and the first magnetic member 25 has a first magnetic pole (such as N pole or S pole). In this embodiment, one side of the active roller 20 has an inner recess 22, and the first magnetic member 25 is fixed in the inner recess 22. The first limiting structure 21 comprises a plurality of grooves 211. The grooves 211 are radially formed on a bottom portion of the inner recess 22, surround the axis of the active roller 20, and surround the first magnetic member 25.

In some embodiments, the first magnetic member 25 may be a magnet, a ferrite, or a ferromagnetic member (such a metallic member made of iron, nickel, or cobalt) with magnetic property. Moreover, the shape of the first magnetic member 25 may be round (as shown in FIG. 4 and FIG. 5), rectangular, elliptical, or the like.

As shown in FIG. 3 to FIG. 5, the size of the passive roller 30 is less than the size of the active roller 20, and the passive roller 30 is movably disposed in the inner recess 22 of the active roller 20, so that the passive roller 30 can be limited. In this embodiment, a first connection portion 23 is further on the axis of the active roller 20, and the first connection portion 23 is in the inner recess 22, a second connection portion 33 is further on the axis of the passive roller 30, and the first connection portion 23 is slidably connected to the second connection portion 33, so that the passive roller 30 can be slid with respect to the active roller 20 along an axial direction. Furthermore, in this embodiment, the first connection portion 23 of the active roller 20 is a shaft, and the second connection portion 33 of the passive roller 30 is a bushing, and the second connection portion 33 is movably fitted over the first connection portion 23; for example, the second connection portion 33 may be fitted over first connection portion 23 in a clearance fit manner, so that the second connection portion 33 can be moved with respect to the first connection portion 23. In some embodiments, the structure of the first connection portion 23 of the active roller 20 and the structure of the second connection portion 33 of the passive roller 30 may be exchanged; for example, the first connection portion 23 may be a bushing, and the second connection portion 33 may be shaft, but the instant disclosure is not limited thereto.

As shown in FIG. 3 to FIG. 5, the passive roller 30 comprises a second limiting structure 31 and a second magnetic member 35, and the second magnetic member 35 has a second magnetic pole (such as N pole or S pole). The second magnetic member 35 is fixed on one side of the passive roller 30 facing the first limiting structure 21. Therefore, the first magnetic member 25 is adjacent to the second magnetic member 35. In this embodiment, the second limiting structure 31 is also disposed on the side of the passive roller 30 facing the first limiting structure 21, and the second limiting structure 31 comprises a plurality of protrusions 311. The protrusions 311 surround the axis of the passive roller 30 and the second magnetic member 35. Therefore, when the active roller 20 and the passive roller 30 are moved adjacent to each other, the protrusions 311 of the passive roller 30 respectively contact the grooves 211 of the active roller 20, so that the active roller 20 and the passive roller 30 can rotate synchronously.

Further, as shown in FIG. 5, in this embodiment, each of the protrusions 311 has a convex surface 312, and each of the grooves 211 has a concave surface 212. In other words, in this embodiment, each of the protrusions 311 is a curved protrusion, and each of the grooves 211 is a curved groove. Therefore, during the process of the active roller 20 and the passive roller 30 being moved adjacent to each other, if the position of each of the protrusions 311 has a slight offset with respect to the position of a corresponding one of the grooves 211 and thus the positions the protrusions 311 do not correspond to the positions of the grooves 211, each of the protrusions 311 can still contact the corresponding one of the grooves 211 properly through the guiding between the convex surfaces 312 and the concave surfaces 212.

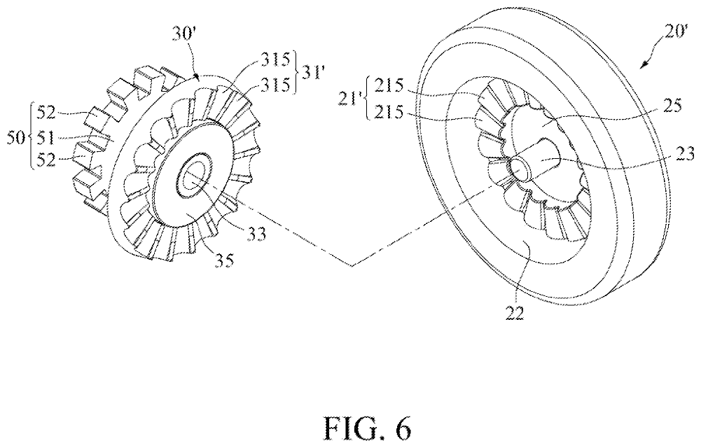

Furthermore, the first limiting structure 21 of the active roller 20 and the second limiting structure 31 of the passive roller 30 may be exchanged. For example, as shown in FIG. 6, in the second embodiment of the instant disclosure, the first limiting structure 21′ of the active roller 20′ comprises a plurality of protrusions 215, and the protrusions 215 surround the axis of the active roller 20′; the second limiting structure 31′ of the passive roller 30′ comprises a plurality of grooves 315, and the grooves 315 surround the axis of the passive roller 30′. Accordingly, when the active roller 20′ and the passive roller 30′ are moved adjacent to each other, the protrusions 215 of the active roller 20′ respectively contact the grooves 315 of the passive roller 30′, so that the active roller 20′ and the passive roller 30′ can rotate synchronously.

As shown in FIG. 3 to FIG. 5, the polarity of the first magnetic pole of the first magnetic member 25 of the active roller 20 is the same as the polarity of the second magnetic pole of the second magnetic member 35 of the passive roller 30, so that a magnetic repulsion force is between the first magnetic pole and the second magnetic pole. For example, if the first magnetic pole of the first magnetic member 25 facing the second magnetic member 35 is an N pole, the second magnetic pole of the second magnetic member 35 facing the first magnetic member 25 is also an N pole. Therefore, because of the magnetic repulsion force, a space can be kept between the first magnetic member 25 and the second magnetic member 35.

In some embodiments, the second magnetic member 35 may be a magnet, a ferrite, or a ferromagnetic member (such a metallic member made of iron, nickel, or cobalt) with magnetic property. Moreover, the shape of the second magnetic member 35 may be round (as shown in FIG. 4 and FIG. 5), rectangular, elliptical, or the like.

In some embodiments, the actuation member 40 is adapted to drive the passive roller 30 to move with respect to the active roller 20. For example, the actuation member 40 can drive the passive roller 30 to move electrically or manually. For instance, the actuation member 40 may be a device capable of converting a control signal into a power for pushing a controlled object. The actuation member 40 may comprise an electric motor 46 (such as a linear motor, a DC/AC motor, a stepper motor, a pneumatic/hydraulic motor) so as to control the controlled object to perform a linear motion or a rotational motion.

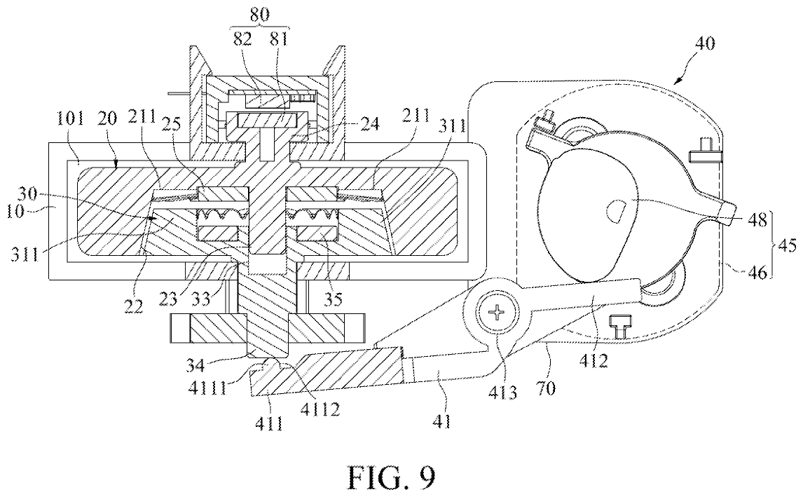

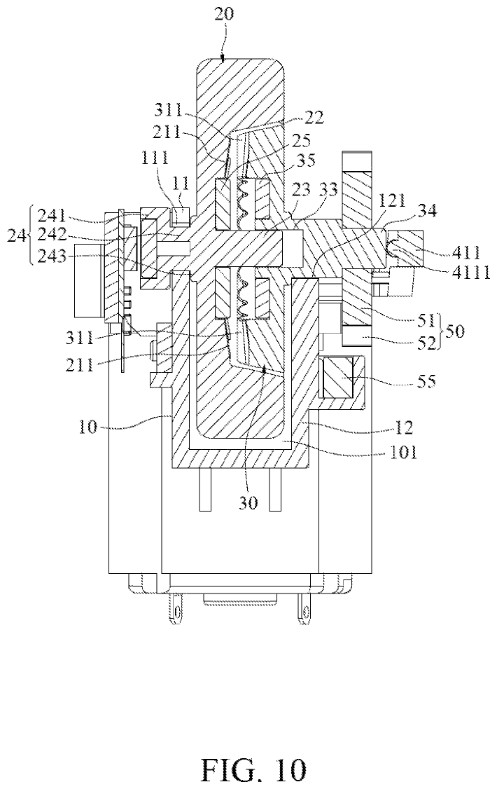

The actuation member 40 can be switched to a first mode or a second mode. As shown in FIG. 7 and FIG. 8, when the actuation member 40 is in the first mode, the actuation member 40 drives the passive roller 30 to move adjacent to the active roller 20, so that the first limiting structure 21 and the second limiting structure 31 are assembled with each other, and the active roller 20 and the passive roller 30 can rotate synchronously. Hence, a first operation mode is achieved. As shown in FIG. 9 and FIG. 10, when the actuation member 40 is in the second mode, the actuation member 40 releases the passive roller 30, so that the magnetic repulsion force between the first magnetic member 25 and the second magnetic member 35 drives the passive roller 30 to move away from the active roller 20, and the first limiting structure 21 and the second limiting structure 31 are separated from each other. Hence, the active roller 20 and the passive roller 30 do not rotate synchronously, and a second operation mode is achieved. Therefore, according to one or some embodiments of the instant disclosure, the actuation member 40 can be switched to the first mode or the second mode, so that the active roller 20 and the passive roller 30 can rotate synchronously or can be separated from each other. Hence, the roller input device 1 can be switched to different operation modes to meet users' different operation requirements. The details are further described in the following paragraphs with accompanying figures.

As shown in FIG. 7 and FIG. 8, in this embodiment, the actuation member 40 comprises a driven component 41 and a driving component 45, and the driven component 41 is connected between the driving component 45 and the passive roller 30. In this embodiment, the driven component 41 is an elongated bar and comprises a driving end 411, a driven end 412, and a pivot portion 413. The driving end 411 and the driven end 412 are two opposite ends of the driven component 41. The pivot portion 413 is between the driving end 411 and the driven end 412, the driving end 411 abuts against the second rotation shaft 34 of the passive roller 30, and the pivot portion 413 is pivotally connected to a mount 70. Therefore, when the driven component 41 is subjected to a force, the driven component 41 can swing with respect to the base 10 and the mount 70 by taking the pivot portion 413 as the swinging fulcrum. As shown in FIG. 4, in this embodiment, the mount 70 is connected to the base 10. The mount 70 and the base 10 may be assembled with each other or integrated as a one-piece structure. Moreover, both of the driven component 41 and the driving component 45 of the actuation member 40 may be disposed on the mount 70.

Furthermore, as shown in FIG. 4, FIG. 5, FIG. 7, and FIG. 8, in this embodiment, the mount 70 is a hollow housing, the driving component 45 comprises an electric motor 46 and a rotatable cam 48, the electric motor 46 is disposed in the mount 70, the rotatable cam 48 is connected to the rotation shaft of the electric motor 46 and is above the mount 70, and the rotatable cam 48 leans against the driven end 412 of the driven component 41. Therefore, when the actuation member 40 is in the first mode, the electric motor 46 can drive the rotatable cam 48 to rotate so as to push the driven end 412 of the driven component 41, so that the driven component 41 is rotated with respect to the base 10 by taking the pivot portion 413 as the rotation center, and the driving end 411 of the driven component 41 presses the second rotation shaft 34 of the passive roller 30. Because the force of the driving end 411 pressing the passive roller 30 is greater than the magnetic repulsion force between the first magnetic member 25 and the second magnetic member 35, the passive roller 30 can be moved toward the active roller 20, so that the protrusions 311 of the passive roller 30 respectively contact the grooves 211 of the active roller 20. Therefore, when the user operates the active roller 20 to roll the active roller 20, the passive roller 30 and the active roller 20 can rotate synchronously, so that the passive roller 30 can provide a counterweight effect, thus providing the user with a stably operation feeling. Moreover, through the structure of the active roller 20 for connecting to the passive roller 30, the user can have a certain operation feeling upon operating the active roller 20.

As above, as shown in FIG. 3 to FIG. 8, the roller input device 1 comprises a metallic gear 50 and a magnetic body 55, wherein the metallic gear 50 and the magnetic body 55 may be magnet, ferrite, or ferromagnetic members (such as metallic members made of iron, nickel, or cobalt) with magnetic property. The metallic gear 50 and the passive roller 30 are coaxially connected to each other, so that the metallic gear 50 and the passive roller 30 can rotate synchronously. The metallic gear 50 comprises a main body 51 and a plurality of tooth portions 52, and the tooth portions 52 are spaced from each other and annularly arranged on the periphery of the main body 51. The magnetic body 55 is fixed on one side of the base 10 and adjacent to the periphery of the metallic gear 50, and each of the tooth portions 52 of the metallic gear 50 and the magnetic body 55 are capable of being magnetically attracted with each other. Accordingly, as mentioned above, when the actuation member 40 is in the first mode, the passive roller 30 and the active roller 20 can rotate synchronously. Moreover, during the process that the user operates the active roller 20 to roll the active roller 20, the passive roller 30 and the metallic gear 50 can rotate synchronously. When the position of the magnetic body 55 corresponds to the positions of the tooth portions 52, the magnetic attraction force between the magnetic body 55 and the tooth portions 52 allows the user to feel that the operation of the active roller 20 stops temporarily. On the other hand, when the position of the magnetic body 55 is misaligned with the positions of the tooth portions 52, the magnetic attraction force does not generate between the magnetic body 55 and the tooth portions 52. Therefore, during the process of rotating the active roller 20, through the change of the magnetic body 55 and the tooth portions 52, the user can have the stepped operation feeling. Hence, as compared with a roller input device which adopts the mechanical structure to achieve the stepped operation feeling, according to one or some embodiments of the instant disclosure, the roller input device 1 can achieve the advantages of preventing the mechanical error, reducing the operation noise, and reducing the friction loss.

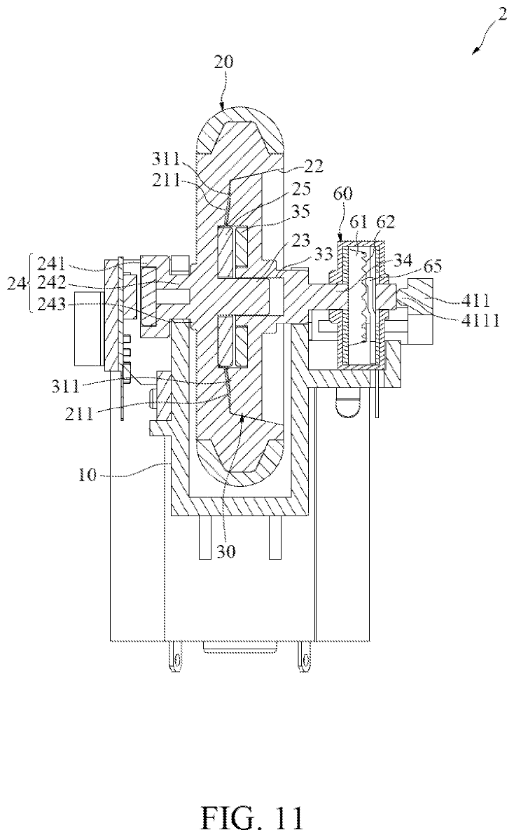

Alternatively, as shown in FIG. 11, in the third embodiment of the instant disclosure, the roller input device 2 may comprise a tooth disc 61 and an elastic member 65, the tooth disc 61 and the passive roller 30 are coaxially connected to each other, so that the tooth disc 61 and the passive roller 30 can rotate synchronously. The tooth disc 61 has an annular tooth portion 62, the elastic member 65 may be an elastic piece, a spring, an elastic arm, and the elastic member 65 elastically abuts against the annular tooth portion 62. Therefore, as mentioned above, when the actuation member 40 is in the first mode, the passive roller 30 and the active roller 20 can rotate synchronously. During the process that the user operates the active roller 20 to roll the active roller 20, the passive roller 30 and the tooth disc 61 can rotate synchronously, and the user can also have the stepped operation feeling. In some embodiments, the tooth disc 61 and the elastic member 65 maybe in an encoder 60.

As shown in FIG. 9 and FIG. 10, when the actuation member 40 is in the second mode, the electric motor 46 can drive the rotatable cam 48 to rotate so as to release the driven end 412 of the driven component 41, so that the driving end 411 of the actuation member 40 releases the passive roller 30. At this moment, the magnetic repulsion force between the first magnetic member 25 and the second magnetic member 35 can push the passive roller 30 to move away from the active roller 20, so that the first limiting structure 21 and the second limiting structure 31 are separated from each other. Therefore, when the user operates the active roller 20 to roll the active roller 20, the passive roller 30 does not rotate synchronously. Therefore, during the process that the active roller 20 is rotated by the user, the active roller 20 can be rotated quickly or can perform a finely operation without having an excessive resistance. Hence, according to one or some embodiments of the instant disclosure, the roller input device 1 can be provided for meeting certain operation conditions (such as the user has to operate the active roller 20 for a long time or for a long distance, or the user has to allow the active roller 20 to perform a more finely scroll operation).

As shown in FIG. 4, FIG. 7, and FIG. 9, in this embodiment, the roller input device 1 further comprises a rolling detection module 80. The rolling detection module 80 comprises a magnet 81 and a hall sensor 82. The magnet 81 is disposed on the first rotation shaft 24 of the active roller 20, and the magnet 81 may be a permanent magnet (such as an alnico magnet or an NdFeB magnet) and thus has two different magnetic poles (the N pole and the S pole). The hall sensor 82 is disposed on the base 10 and adjacent to the magnet 81. Therefore, when the magnet 81 and the active roller 20 rotate synchronously, the hall sensor 82 can detect the change of the magnetic field so as to determine the distance, the position, and the rotation speed of the active roller 20.

Further, as shown in FIG. 7 to FIG. 10, the driving end 411 of the driven component 41 of the actuation member 40 has a protruding portion 4111, and the protruding portion 4111 has a curved surface 4112 (for example a semispherical surface or an arced surface), and the curved surface 4112 abuts against the second rotation shaft 34 of the passive roller 30. Therefore, the contact between the protruding portion 4111 and the passive roller 30 is in a point-contact manner or a linear-contact manner, thereby greatly reducing the friction during the rotation of the passive roller 30.

Further, as shown in FIG. 4 and FIG. 8, in this embodiment, a reinforcement rib 122 further protrudes from the second sidewall 12 of the base 10, and the reinforcement rib 122 is supported below the second rotation shaft 34 of the passive roller 30. Therefore, the second rotation shaft 34 of the passive roller 30 not only can be supported by the hole wall of the second pivot portion 121, the second rotation shaft 34 of the passive roller 30 but also can be supported by the reinforcement rib 122 so as to achieve a better supporting effect. Therefore, during the process that the passive roller 30 is moved with respect to the active roller 20, the passive roller 30 can be moved stably.

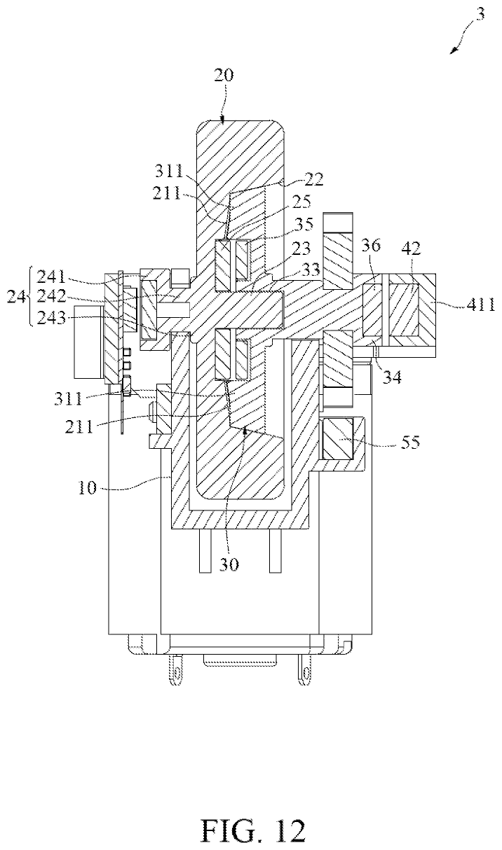

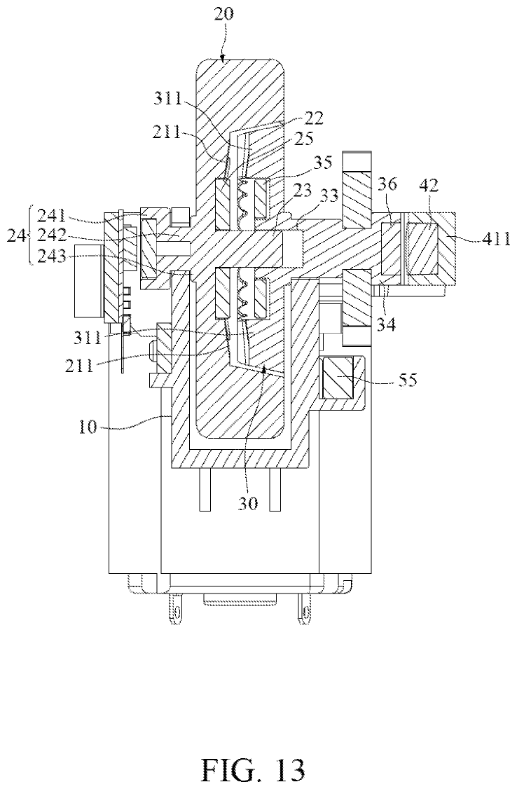

In some embodiments, the actuation member 40 can also drive the passive roller 30 to move with respect to the active roller 20 in a non-contact manner. As shown in FIG. 12 and FIG. 13, in the fourth embodiment of the instant disclosure, a third magnetic member 42 is on the driving end 411 of the driven component 41 of the roller input device 3, and a fourth magnetic member 36 is on the second rotation shaft 34 of the passive roller 30, wherein the third magnetic member 42 and the fourth magnetic member 36 may be magnet, ferrite, or ferromagnetic members (such as metallic members made of iron, nickel, or cobalt) with magnetic property, and the third magnetic member 42 and the fourth magnetic member 36 are adjacent to each other and do not contact each other. Moreover, the third magnetic member 42 has a third magnetic pole, the fourth magnetic member 36 has a fourth magnetic pole, and the polarity of the third magnetic pole is the same as the polarity of the fourth magnetic pole, so that the third magnetic pole and the fourth magnetic pole are repelled from each other. For example, supposed that the magnetic pole of the third magnetic member 42 is an S pole, the magnetic pole of the fourth magnetic member 36 is also an S pole. Therefore, when the actuation member 40 is in the first mode, the driving end 411 of the driven component 41 is moved toward the passive roller 30, and the magnetic repulsion force between the third magnetic member 42 and the fourth magnetic member 36 drives the passive roller 30 to move toward the active roller 20, so that the protrusions 311 of the passive roller 30 respectively correspond to the grooves 211 of the active roller 20. When the actuation member 40 is in the second mode, the magnetic repulsion force between the first magnetic member 25 and the second magnetic member 35 also drive the passive roller 30 to move away from the active roller 20, so that the first limiting structure 21 and the second limiting structure 31 can be separated from each other.

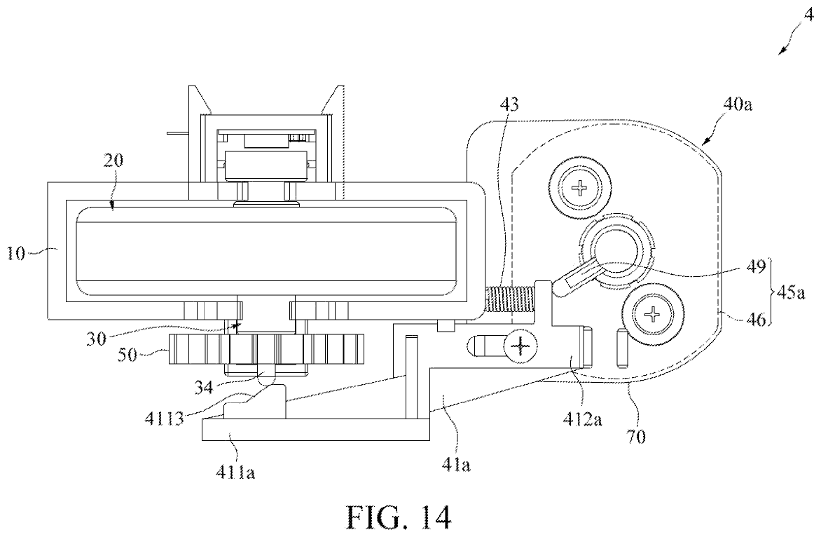

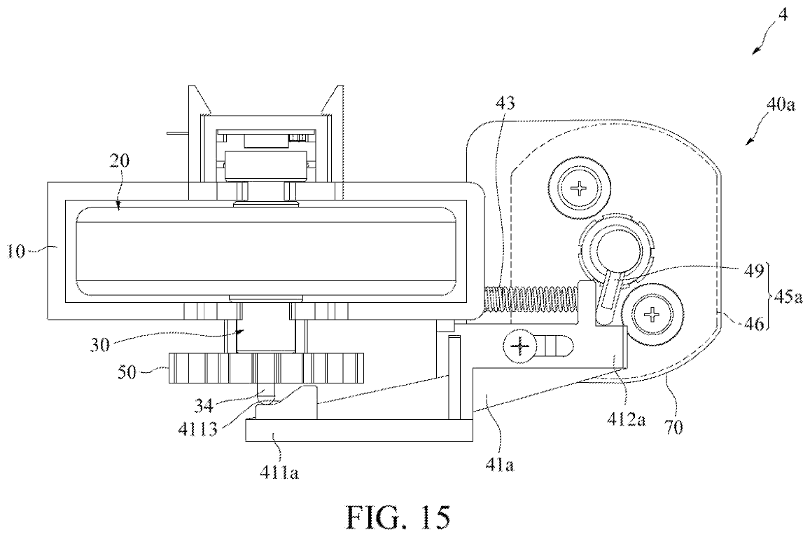

In some embodiments, when the actuation member 40 is in the first mode, the driven component 41 can also perform a linear motion to drive the passive roller 30 to move adjacent to the active roller 20. As shown in FIG. 14 and FIG. 15, in the fifth embodiment of the instant disclosure, the actuation member 40a of the roller input device 4 comprises a driven component 41a and a driving component 45a, the driven component 41a is connected between the driving component 45a and the passive roller 30, and the driven component 41a is slidably disposed on the mount 70. In this embodiment, the driven component 41a is an elongated bar and comprises a driving end 411a and a driven end 412a. The driving end 411a abuts against the second rotation shaft 34 of the passive roller 30 and has a guiding bevel 4113. The driving component 45a comprises an electric motor 46 and a swingable bar 49, the swingable bar 49 is connected to the rotation shaft of the electric motor 46, and the swingable bar 49 leans against the driven end 412a of the driven component 41a. Accordingly, when the actuation member 40a is in the first mode, the electric motor 46 can drive the swingable bar 49 to push the driven end 412a of the driven component 41a, so that the driven component 41a can slide linearly with respect to the base 10. At this moment, the driving end 411a of the driven component 41a abuts the second rotation shaft 34 of the passive roller 30 through the guiding bevel 4113, so that the passive roller 30 can be moved toward the active roller 20. When the actuation member 40a is in the second mode, the magnetic repulsion force between the first magnetic member 25 and the second magnetic member 35 also can drive the passive roller 30 to move away from the active roller 20, so that the first limiting structure 21 and the second limiting structure 31 can be separated from each other, and the passive roller 30 can drive the driven component 41a to slide resiliently.

Further, as shown in FIG. 14 and FIG. 15, in this embodiment, the actuation member 40a further has a resilient member 43. For example, the resilient member 43 may be an elastic member such as a spring, an elastic piece, or a rubber, and the resilient member 43 abuts against the base 10 and the driven component 41a. When the actuation member 40a is in the first mode, the driven component 41a can compress the resilient member 43 to store the elastic force in the resilient member 43; when the actuation member 40a is in the second mode, the elastic force stored in the resilient member 43 can further help the driven component 41a slide resiliently.

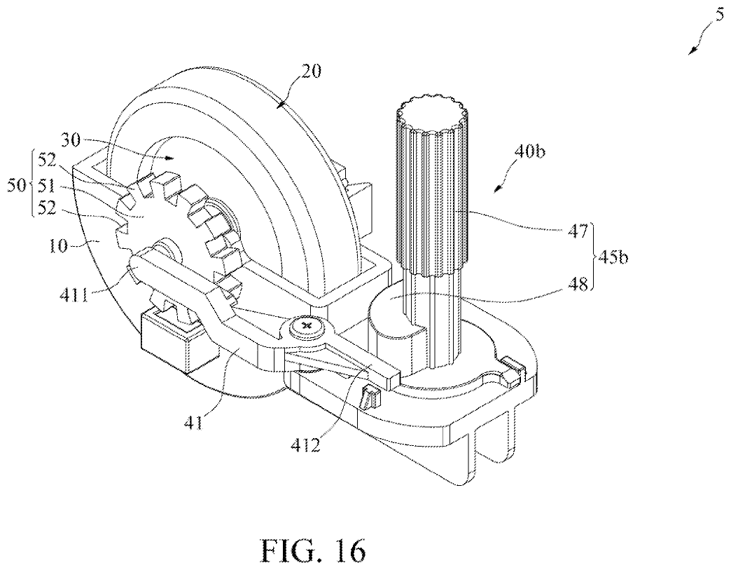

In some embodiments, the actuation member 40 can be driven manually. As shown in FIG. 16, in the sixth embodiment of the instant disclosure, the driving component 45b of the actuation member 40b of the roller input device 5 comprises a manual operating handle 47 and a rotatable cam 48. The manual operating handle 47 is connected to the rotatable cam 48, so that the rotatable cam 48 can be rotated manually. Moreover, the rotatable cam 48 leans against the driven end 412 of the driven component 41. Hence, the manual operating handle 47 is connected to the driven end 412 through the rotatable cam 48. When the user rotates the manual operating handle 47 to allow the actuation member 40b in the first mode, the manual operating handle 47 drives the rotatable cam 48 to rotate synchronously, so that the rotatable cam 48 drives the driven component 41 to drive the passive roller 30 to move toward the active roller 20. When the user rotates the manual operating handle 47 to allow the actuation member 40 in the second mode, the rotatable cam 48 can release the driven component 41, so that the magnetic repulsion force between the first magnetic member 25 and the second magnetic member 35 drives the passive roller 30 to move away from the active roller 20, and the first limiting structure 21 and the second limiting structure 31 can be separated from each other.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A roller input device comprising:
a base;
an active roller rotatably disposed on the base, wherein the active roller comprises a first limiting structure and a first magnetic member, and the first magnetic member has a first magnetic pole;
a passive roller rotatably disposed on the base, wherein the passive roller comprises a second limiting structure and a second magnetic member, and the second magnetic member has a second magnetic pole; the first magnetic member and the second magnetic member are adjacent to each other, and a polarity of the first magnetic pole is the same as a polarity of the second magnetic pole, so that a magnetic repulsion force is between the first magnetic pole and the second magnetic pole; and
an actuation member capable of being selectively switched to a first mode or a second mode;
wherein when the actuation member is in the first mode, the actuation member drives the passive roller to move adjacent to the active roller, so that the first limiting structure and the second limiting structure are assembled with each other, and the active roller and the passive roller rotate synchronously;
wherein when the actuation member is in the second mode, the actuation member releases the passive roller to allow the magnetic repulsion force to drive the passive roller to move away from the active roller, so that the first limiting structure and the second limiting structure are separated from each other.

2. The roller input device according to claim 1, wherein the first limiting structure comprises a plurality of grooves surrounding an axis of the active roller, and the second limiting structure comprises a plurality of protrusions surrounding an axis of the passive roller; when the actuation member is in the first mode, the protrusions are in the grooves, respectively.

3. The roller input device according to claim 1, wherein the first limiting structure comprises a plurality of protrusions surrounding an axis of the active roller, and the second limiting structure comprises a plurality of grooves surrounding an axis of the passive roller; when the actuation member is in the first mode, the protrusions are in the grooves, respectively.

4. The roller input device according to claim 2, wherein each of the protrusions has a convex surface, and each of the grooves has a concave surface.

5. The roller input device according to claim 3, wherein each of the protrusions has a convex surface, and each of the grooves has a concave surface.

6. The roller input device according to claim 1, further comprising a metallic gear and a magnetic body, wherein the metallic gear and the passive roller are coaxially connected to each other, the metallic gear comprises a main body and a plurality of tooth portions, the tooth portions are annularly arranged on a periphery of the main body, the magnetic body is adjacent to the metallic gear, and each of the tooth portions and the magnetic body are capable of being magnetically attracted with each other.

7. The roller input device according to claim 1, further comprising a tooth disc and an elastic member, wherein the tooth disc and the passive roller are coaxially connected to each other, the tooth disc has an annular tooth portion, and the elastic member elastically abuts against the annular tooth portion.

8. The roller input device according to claim 1, wherein one side of the active roller has an inner recess, and the passive roller is in the inner recess.

9. The roller input device according to claim 1, wherein a first connection portion is on an axis of the active roller, a second connection portion is on an axis of the passive roller, and the first connection portion is slidably connected to the second connection portion.

10. The roller input device according to claim 9, wherein the first connection portion is a shaft, and the second connection portion is a bushing.

11. The roller input device according to claim 1, wherein the base has a first sidewall and a second sidewall opposite to the first sidewall; the first sidewall has a first pivot portion, the second sidewall has a second pivot portion, a first rotation shaft is on an axis of the active roller, the first rotation shaft is pivotally connected to the first pivot portion, a second rotation shaft is on an axis of the passive roller, and the second rotation shaft is pivotally connected to the second pivot portion.

12. The roller input device according to claim 11, wherein a reinforcement rib is further on the second sidewall, and the reinforcement rib is supported below the second rotation shaft.

13. The roller input device according to claim 11, wherein the first rotation shaft has a first section, a middle section, and a second section, the middle section is connected between the first section and the second section, and the middle section is in the first pivot portion; a diameter of the first section is greater than a diameter of the middle section, and a diameter of the second section is greater than the diameter of the middle section.

14. The roller input device according to claim 1, wherein the actuation member comprises a driven component and a driving component, the driven component is connected between the driving component and the passive roller, and the driven component comprises a driving end; when the actuation member is in the first mode, the driving component drives the driven component to perform a relative motion with respect to the base, so that the driving end drives the passive roller to move adjacent to the active roller.

15. The roller input device according to claim 14, wherein the relative motion is a rotational motion or a linear motion.

16. The roller input device according to claim 14, wherein the driving end abuts against the passive roller.

17. The roller input device according to claim 16, wherein the driving end has a protruding portion, the protruding portion has a curved surface, and the curved surface abuts against the passive roller.

18. The roller input device according to claim 14, wherein a third magnetic member is on the driving end, a fourth magnetic member is on the passive roller, the third magnetic member and the fourth magnetic member are adjacent to each other, and a polarity of a magnetic pole of the third magnetic member is the same as a polarity of a magnetic pole of the fourth magnetic member.

19. The roller input device according to claim 14, wherein the driven component comprises a driven end opposite to the driving end, the driving component comprises an electric motor, and the electric motor is connected to the driven end.

20. The roller input device according to claim 14, wherein the driven component comprises a driven end opposite to the driving end, the driving component comprises a manual operating handle, and the manual operating handle is connected to the driven end.
